(19) United States
(12) Patent Application Publication
(10) Pub. No.: US 2015/0242201 A1
(43) Pub. Date: Aug. 27, 2015

(54) METHOD FOR UPDATING FIRMWARE AND ELECTRONIC DEVICE THEREOF

(71) Applicant: Samsung Electronics Co., Ltd., Suwon-si (KR)

(72) Inventors: Jong-Tae KIM, Yongin-si (KR); Sang-Eun HA, Suwon-si (KR); Chenchun-Yen IAN, Suwon-si (KR)

(21) Appl. No.: 14/625,159

(22) Filed: Feb. 18, 2015

(30) Foreign Application Priority Data
Feb. 21, 2014 (KR) 10-2014-0020874

(51) Int. Cl. G06F 9/445; G06F 3/06

(52) U.S. Cl. CPC G06F 8/665; G06F 3/0679; G06F 3/0607; G06F 3/0689; G06F 3/0659; G06F 2206/1014

(57) ABSTRACT

An apparatus and a method for updating firmware of an internal device in an electronic device are provided. The method includes executing a control command for a firmware update of the internal device, identifying data for the firmware update of the internal device, and updating the firmware of the internal device by using the data.

### CROSS-REFERENCE TO RELATED APPLICATION(S)

This application claims the benefit under 35 U.S.C. §119(a) of a Korean patent application filed on Feb. 21, 2014 in the Korean Intellectual Property Office and assigned Serial number 10-2014-0020874, the entire disclosure of which is hereby incorporated by reference.

### TECHNICAL FIELD

The present disclosure relates to an electronic device. More particularly, the present disclosure relates to an apparatus and a method for managing firmware of an internal device in an electronic device.

### BACKGROUND

With the development of information communication technology and a semiconductor technology, various types of electronic devices have been developed into multimedia devices for providing various multimedia services. For example, electronic devices may provide various multimedia services, such as a broadcast service, a wireless Internet service, a camera service, a music playback service, and the like.

An electronic device may include firmware that is a program for controlling hardware. The electronic device may correct a function error or add a new function through firmware update.

The above information is presented as background information only to assist with an understanding of the present disclosure. No determination has been made, and no assertion is made, as to whether any of the above might be applicable as prior art with regard to the present disclosure.

### SUMMARY

The electronic device may include at least one internal device (e.g., a memory, an input/output device, a display, and the like) for executing various functions. At least one internal device may embed its firmware.

The firmware of at least one internal device may be updated along with firmware of the electronic device that is a host (e.g., an operating system). Therefore, firmware of at least one internal device included in the electronic device is dependent on a version of host firmware, and there may occur unnecessary load in which the host firmware is newly generated in order to update firmware of the internal device.

When a signal not related with firmware update is input or output upon updating of firmware of the electronic device, there may occur a case in which the electronic device fails to update firmware or an apparatus for updating firmware is broken down. For example, when firmware of a storage device (e.g., a memory) included in the electronic device is updated, there may occur a problem that updating of firmware of the storage device has failed or the storage device is broken down since input and output with respect to the storage device which are not related to updating of firmware of the storage device are generated according to operation of an operating system in the electronic device.

Therefore, a need exists for an apparatus and a method for managing firmware of an internal device in an electronic device.

Aspects of the present disclosure are to address at least the above-mentioned problems and/or disadvantages and to provide at least the advantages described below. Accordingly, an aspect of the present disclosure is to provide an apparatus and a method for managing firmware of an internal device in an electronic device.

Another aspect of the present disclosure is to provide an apparatus and a method for updating firmware of an internal device in a state in which input and output with respect to the internal device are restricted in an electronic device.

Another aspect of the present disclosure is to provide an apparatus and a method for separating a control command and data for firmware update of an internal device from each other and storing and managing the control command and the data in an electronic device.

Another aspect of the present disclosure is to provide an apparatus and a method for delaying mounting of system information and updating firmware of a storage device in a state in which input and output with respect to the storage device are restricted in an electronic device.

Another aspect of the present disclosure is to provide an apparatus and a method for unmounting system information and updating firmware of a storage device in a state in which input and output with respect to the storage device are restricted in an electronic device.

In accordance with an aspect of the present disclosure, a method for updating firmware of an internal device in an electronic device is provided. The method includes executing a control command for a firmware update of the internal device, identifying data for the firmware update of the internal device, and updating the firmware of the internal device based on the data.

In accordance with another aspect of the present disclosure, an electronic device is provided. The electronic device includes at least one internal device and at least one processor configured to execute a control command for a firmware update of the at least one internal device for updating of firmware of the at least one internal device, to identify data for the firmware update of the at least one internal device, and to update the firmware of the at least one internal device by using the data.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A illustrates a block diagram of an electronic device according to an embodiment of the present disclosure;

FIG. 1B illustrates an internal block diagram of a memory according to an embodiment of the present disclosure;

FIG. 2 illustrates a block diagram of a firmware control module according to an embodiment of the present disclosure;

FIG. 3 illustrates a block diagram of an electronic device according to an embodiment of the present disclosure;

FIG. 4 illustrates a block diagram of an electronic device according to an embodiment of the present disclosure;

FIG. 5 illustrates a process for updating firmware of an internal device in an electronic device according to an embodiment of the present disclosure;

FIG. 6 illustrates a process for updating firmware of an internal device upon booting in an electronic device according to an embodiment of the present disclosure;

FIG. 7 illustrates a process for updating firmware of an internal device based on a firmware version in an electronic device according to an embodiment of the present disclosure;

FIG. 8 illustrates a process for updating firmware of an internal device during running in an electronic device according to an embodiment of the present disclosure;

FIG. 9 illustrates a process for storing firmware data in an electronic device according to an embodiment of the present disclosure;

FIG. 10 illustrates a process for selectively storing firmware data provided from an external electronic device in an electronic device according to an embodiment of the present disclosure;

FIG. 11 illustrates a process for storing firmware data in an external electronic device according to an embodiment of the present disclosure;

FIG. 12 illustrates a process for storing firmware data provided from an external electronic device in an electronic device according to an embodiment of the present disclosure;

FIG. 13 illustrates a process for selectively transmitting firmware data in an external electronic device according to an embodiment of the present disclosure;

FIG. 14 illustrates a process for transmitting firmware data in an external electronic device according to an embodiment of the present disclosure;

FIG. 15 illustrates a process for selectively storing firmware data provided from an external electronic device in an electronic device according to another embodiment of the present disclosure;

FIG. 16 illustrates a configuration for transmitting firmware data according to an embodiment of the present disclosure;

FIGS. 17A and 17B illustrate screen configurations for management of firmware data according to various embodiments of the present disclosure;

FIG. 18 illustrates a configuration of a memory in which a control command for a firmware update is executed according to an embodiment of the present disclosure; and

FIG. 19 illustrates a configuration of firmware data according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The terms such as “includes” and “may include” when used herein, specify the presence of stated features, operations, or elements, but do not limit one or more additional functions, operations or elements. It will be understood that terms such as “comprise”, “include”, and “have”, when used herein, specify the presence of stated features, integers, operations, elements, components, or combinations thereof, but do not preclude the presence or addition of one or more other features, integers, operations, elements, components, or combinations thereof.

The term “or” as used herein is to be interpreted as an inclusive or meaning any one or any combination. For example, “A or B” may be intended to include A, to include B, or to include both A and B.

Although terms such as “first” and “second” may be used herein to describe various elements, these elements should not be limited by these terms. For example, the terms do not limit the order and/or importance of the elements. These terms are only used to distinguish one element from another element. For example, a first user equipment and a second user equipment are both a user equipment and represent different user equipment. For example, a first element could be termed a second element, and, similarly, a second element could be termed a first element, without departing from the scope of the present disclosure.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terms used herein are for the purpose of describing various embodiments only and are not intended to be limiting of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An electronic device according to an embodiment of the present disclosure may be a device including a storage device. Examples of the electronic device may include a smart phone, a tablet personal computer, a mobile phone, a video telephone, an e-book reader, a desktop personal computer, a laptop personal computer, a netbook computer, a personal digital assistant (PDA), a portable multimedia player, a Motion Pictures Expert Group (MPEG-1 or MPEG-2) Audio Layer 3 (MP3) player, a mobile medicine equipment, a camera, or a wearable device (e.g., a head-mounted-device (HMD), such as an electronic glasses, an electronic clothing, an electronic bracelet, an electronic necklace, an electronic appcessory, an electronic tattoo, a smart watch, and the like).

In various embodiments of the present disclosure, the electronic device may be a smart home appliance having a storage device. For example, the smart home appliance may include at least one of a television, a digital video desk (DVD) player, a stereo, a refrigerator, an air-conditioner, a cleaner, an oven, a microwave oven, a washing machine, an air cleaner, a set-top box, a Television (TV) box (e.g., Samsung HomeSync™, Apple TV™, or Google TV™), a game console, an electronic key, an electronic dictionary, a camcorder, or a digital photo frame.

According to various embodiments of the present disclosure, examples of the electronic device may include at least one of various types of medical equipment (e.g., magnetic resonance angiography (MRA), magnetic resonance imaging (MRI), computed tomography (CT), an imaging device, or an ultrasound imaging device), a navigation device, a global positioning system (GPS) receiver, an event data recorder (EDR), a flight data recorder (FDR), a vehicle infotainment device, a ship electronic equipment (e.g., a ship navigation device or a gyro-compass device), an avionics device, a security equipment, an industrial or a home robot, and the like.

According to an embodiment of the present disclosure, examples of the electronic device may include at least one of a furniture, a portion of a building/structure, an electronic board, an electronic signature receiving device, a projector, and various types of meters (e.g., water, electricity, gas, radio wave, and the like), each of which includes a storage device. The electronic device according to the present disclosure may be a combination of one or more of the above-described devices. It is obvious to those skilled in the art that the electronic device according to the present disclosure is not limited to the above-described devices.

The electronic device according to various embodiments of the present disclosure is described below with reference to accompanying drawings. The term “user” described herein may refer to a human being using the electronic device or an apparatus (e.g., an artificial intelligence electronic device) using the electronic device.

A technology for updating firmware of an internal device in an electronic device will be described in various embodiments of the present disclosure. For example, the internal device may be configured to be connected to the electronic device through a data bus. As another example, the internal device is connected to the electronic device through an external interface, such as a universal serial bus (USB) or a serial interface and may be configured to be attachable to or detachable from the electronic device. For example, the internal device may include a memory, a storage device, a keypad, a touch panel, a display device, and the like.

In various embodiments of the present disclosure, updating of firmware of a storage device may represent a series of operations which update firmware of a device interface of device interfaces (or device controllers) for controlling a storage area storing data included in the storage device and input and output of data with respect to the storage area.

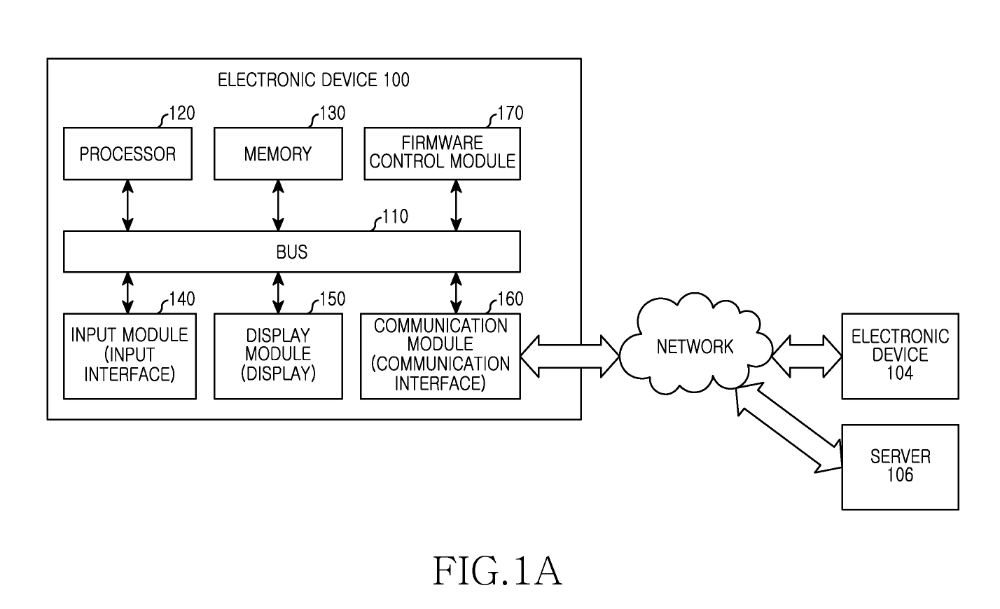

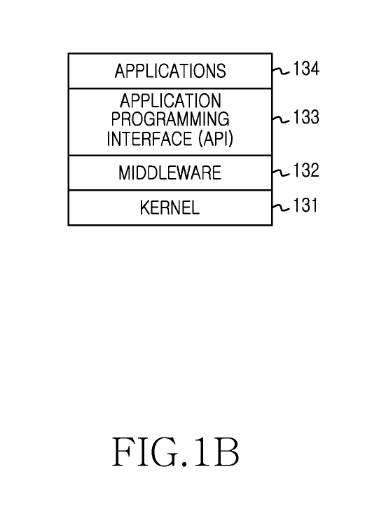

FIG. 1A illustrates a block diagram of an electronic device according to an embodiment of the present disclosure.

Referring to FIG. 1A, an electronic device 100 may include a bus 110, a processor 120, a memory 130, an input module (input interface) 140, a display module (display) 150, a communication module (communication interface) 160, and a firmware control module 170. In this case, a plurality of processors 120 or a plurality of memories 130 may be provided.

The bus 110 may connect elements included in the electronic device 100 to one another, and control communication between the elements included in the electronic device 100.

The processor 120 may perform control such that the electronic device 100 provides various services. For example, the processor 120 may decode a command received from one or more other elements (e.g., the memory 130, the input module 140, the display module 150, the communication module 160, and the firmware control module 170) included in the electronic device 100 through the bus 110, and perform arithmetic operations or data processing according to the decoded command.

The processor 120 may perform control such that the electronic device 100 provides various services, by executing one or more programs stored in the memory 130. For example, upon booting of the electronic device 100, the processor 120 may load a kernel image and random access memory (RAM) disk information stored in the memory 130 into a volatile memory (a main memory area), such as a RAM, and initialize a kernel by using the loaded kernel image. Thereafter, the processor 120 may mount system information stored in the memory 130. When firmware of an internal device (e.g., the memory 130) is updated in the firmware control module 170, the processor 120 may delay mounting of the system information until updating of the firmware of the internal device (e.g., the memory 130) has been completed. In this case, the system information may include information on a platform for operation of the electronic device 100. Mounting of the system information may represent a series of operations for loading system information stored in the memory 130 into a volatile memory area, such as a RAM, by the processor 120 in order to operate a system. For example, in the case of an electronic device supporting android multimedia frameworks, the system information may represent system partitions including information, such as an android kernel mounted by an operating system (e.g., a Linux kernel), system libraries, application runtimes, application frameworks, core applications.

The firmware control module 170 may perform control such that firmware of the internal device (e.g., the memory 130) included in the electronic device 100 is updated. For example, when a control command (e.g., an update code) for firmware update of the internal device (e.g., the memory 130) is stored as RAMdisk information, the firmware control module 170 may perform control such that the control command for firmware update loaded into the RAMdisk area by the processor 120 and firmware of the internal device (e.g., the memory 130) is updated before the system information is mounted by the processor 120. For example, when a kernel is initialized by the processor 120, the firmware control module 170 may execute the control command for firmware update loaded into the RAMdisk area and determine whether firmware data for firmware update of the internal device (e.g., the memory 130) exists. When the firmware data exists, the firmware control module 170 may perform control such that firmware of the internal device (e.g., the memory 130) is updated by using firmware data.

As another example, when an event for firmware update of an internal device (e.g., the memory 130) occurs during running of the electronic device 100, the firmware control module 170 may load a control command for firmware update of the internal device (e.g., the memory 130), which is stored in the memory 130, into a volatile memory (a main memory area), a flash memory, or an auxiliary flash memory. The firmware control module 170 may unmount system information and may perform control such that a control command for firmware update loaded from the memory 130 is executed and firmware of the memory 130 is updated. In this case, updating of the system information may represent a series of operations which remove the system information loaded into the volatile memory area, such as a RAM, from a volatile memory area in order for operation of a system by the processor 120.

The firmware control module 170 may manage firmware data of the internal device (e.g., the memory 130). In this case, the firmware control module 170 may execute an application program for management of firmware data or a control command for firmware update and manage the firmware data of the internal device (e.g., the memory 130). For example, the firmware control module 170 may perform control such that firmware data provided from an external electronic device (e.g., another electronic device 104 or a server 106) is stored in the memory 130. In this case, the firmware control module 170 may perform control such that a version of firmware data provided from the external electronic device is compared with a firmware version of firmware data (or a firmware version of the internal device) stored in the memory 130 and the firmware data provided from the external electronic device is selectively stored in the memory 130. For example, when the version of the firmware data provided from the external electronic device is newer (e.g., the latest version) than the version of the firmware data (or the firmware version of the internal device) stored in the memory 130, the firmware control module 170 may perform control such that the firmware data provided the external electronic device is selectively stored in the memory 130. The firmware control module 170 may identify a firmware version of an internal device by using a preset register of the internal device.

The memory 130 may store an instruction or data received from or generated by one or more elements (the memory 130, the input module 140, the display module 150, the communication module 160, and the firmware control module 170) included in the electronic device 100. For example, the memory 130 may store a control command for firmware update of an internal device (e.g., the memory 130) and firmware data in a logically or physically separated memory area. For example, the memory 130 may store the control command for firmware update in a RAMdisk area adjacent to a kernel image. The memory 130 may update firmware data of an internal device (e.g., the memory 130) stored in the memory 130 by using firmware data provided from an external electronic device based on control of the firmware control module 170.

The memory 130 is logically or physically separate from a storage area storing a command or data and may include a memory area (e.g., a volatile memory area (main memory area), such as a RAM) into which a command or data, which is executed or processed by at least one of the processor 120 and the firmware control module 170, is loaded. For example, the memory 130 may include at least one programming module, such as a kernel 131, middleware 132, an application programming interface (API) 133, and applications 134 as illustrated in FIG. 1B. In this case, each programming module may be configured by software, firmware, hardware, or a combination of at least two thereof.

FIG. 1B illustrates an internal block diagram of a memory according to an embodiment of the present disclosure.

Referring to FIG. 1B, the kernel 131 may control or manage system resources (e.g., the bus 110, the processor 120, and the memory 130) used to execute an operation or a function implemented in remaining other programming modules (e.g., the middleware 132, the API 133, and the applications 134). The kernel 131 may provide an interface for allowing the middleware 132, the API 133, or the applications 134 to access and control or manage respective elements of the electronic device 100.

The middleware 132 may perform a relay role such that the API 133 or the applications 134 communicates with the kernel 131 and transmits and receives data with the kernel 131. The middleware 132 may perform control for a task request received from the applications 134. For example, the middleware 132 may allocate priorities capable of using system resources (e.g., the bus 110, the processor 120, and the memory 130) of the electronic device 100 to at least one application of the applications 134 and perform control (e.g., scheduling or load balancing) for a task request received from the applications 134.

The API 133 may include an interface for allowing the applications 134 to control a function provided by the kernel 131 or the middleware 132. For example, the API 133 may include at least one interface or function (e.g., a command), such as file control, window control, image processing, text messaging control, and the like.

The applications 134 may include at least one application which is capable of being installed and removed by a user. For example, the applications 134 may include at least one of an application designated in the electronic device 100 and an application which is received from an external electronic device (e.g., the other electronic device 104, or the server 106) and installed. For example, the application program for managing firmware data may be an application designated in the electronic device 100 or may be received from the external electronic device (e.g., the other electronic device 104 or the server 106) and installed.

The input module (input interface) 140 may transmit an instruction or data generated by a user's selection to the processor 120 or the memory 130 through the bus 110. For example, the input module 140 may include one or more of a keypad including at least one hardware button and a touch panel for detecting touch information.

The display module 150 may display an image, a video, or data to the user. For example, the display module 150 may display information about application programs executed by the processor 120.

The communication module 160 may connect the electronic device 100 and at least one of the other electronic device 104, the server 106, or at least one peripheral device. For example, the communication module 160 may support a short-range communication protocol (e.g., wireless fidelity (WiFi), Bluetooth, and near-field communication (NFC)), a network communication protocol (e.g., Internet, local area network (LAN), wire area network (WAN), telecommunication network, cellular network, satellite network, and plain old telephone service (POTS)) or a wired communication protocol (e.g., a USB, a high definition multimedia Interface (HDMI), and the like). The communication protocol (e.g., a short-range communication protocol, a network communication protocol, or a wired communication protocol) may be supported by the middleware of the memory 130 and the API. The other electronic device 104 is a peripheral device of the electronic device 100 and may include a device of which the type is identical to or different from that of the electronic device 100.

In the above-described embodiment of the present disclosure, the firmware control module 170 may update firmware of an internal device (e.g., the memory 130) and manage firmware data within one module. The firmware control module 170 may be configured by software to be implemented by a part of a kernel which operates within a host system of the electronic device 100.

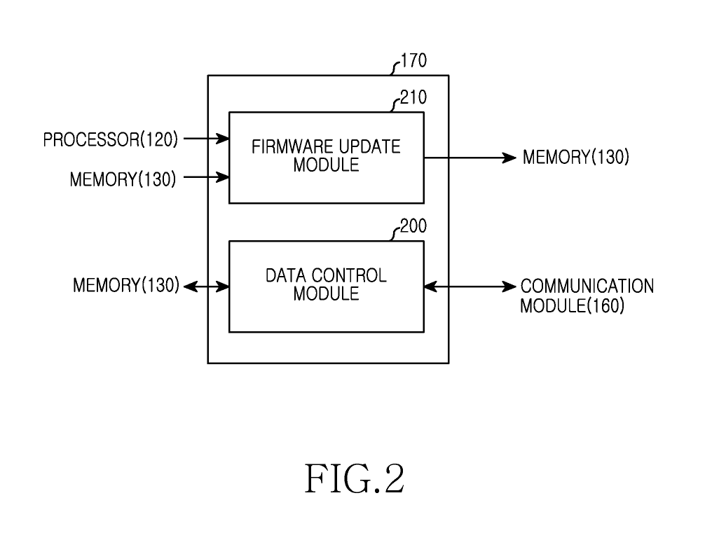

In another embodiment of the present disclosure, the firmware control module 170 may include separate hardware, software, firmware modules, or a combination thereof which update firmware of an internal device (e.g., the memory 130) and manage firmware data as illustrated in FIG. 2.

FIG. 2 illustrates a block diagram of a firmware control module according to an embodiment of the present disclosure.

Referring to FIG. 2, the firmware control module 170 may include a data control module 200 and a firmware update module 210.

The data control module 200 may manage firmware data of an internal device (e.g., the memory 130). In this case, the data control module 200 may execute an application program for management of firmware data or a control instruction for firmware update to manage firmware data of an internal device (e.g., the memory 130). For example, the data control module 200 may perform control such that firmware data provided from an external electronic device (e.g., the other electronic device 104 or the server 106) through the communication module 160 is stored in the memory 130. In this case, the data control module 200 may perform control such that a version of the firmware data provided from the external electronic device is compared with a firmware version (or a firmware version of the internal device) of firmware data stored in the memory 130 and the firmware data provided from the external electronic device is selectively stored in the memory 130. The data control module 200 may identify a firmware version of an internal device by using a preset register of the internal device.

The firmware update module 210 may perform control such that firmware of an internal device (e.g., the memory 130) included in the electronic device 100 is updated. For example, when a control command (e.g., an update code) for update of the firmware of the internal device (e.g., the memory 130) is stored as RAMdisk information, the firmware update module 210 may perform control such that the control command for firmware update which is loaded into a RAMdisk area by the processor 120 is executed and the firmware of the internal device (e.g., the memory 130) is updated before system information is mounted by the processor 120. For example, when the kernel is initialized by the processor 120, the firmware update module 210 may execute the control command for update of the firmware loaded into the RAMdisk area and determine whether there is firmware data for update of the firmware of the internal device (e.g., the memory 130). When there is firmware data, the firmware update module 210 may perform control such that the firmware of the internal device (e.g., the memory 130) is updated by using the firmware data.

As another example, when an event for update of the firmware of the internal device (e.g., the memory 130) occurs during running of the electronic device 100, the firmware update module 210 may load the control command for update of the firmware of the internal device (e.g., the memory 130), which is stored in the memory 130, into a volatile memory (a main memory area), such as a RAM, a flash memory, or an auxiliary flash memory. The firmware control module 170 may unmount the system information and perform control such that the control command for firmware update loaded from the memory 130 is executed and the firmware of the memory 130 is updated.

In the above-described embodiment of the present disclosure, the electronic device 100 may update the firmware of the internal device (e.g., the memory 130) and manage firmware data by using the firmware control module 170.

In another embodiment of the present disclosure, the electronic device 100 may update the firmware of the internal device (e.g., the memory 130) and manage firmware data by using the processor 120.

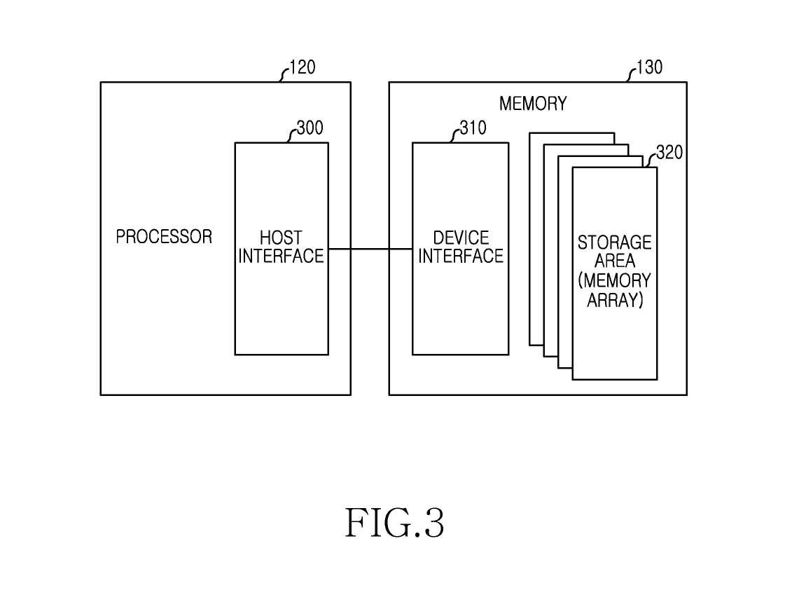

FIG. 3 illustrates a block diagram of an electronic device according to an embodiment of the present disclosure.

Referring to FIG. 3, the processor 120 may include a host interface (or host controller) 300 that controls data transmission and reception with the memory 130.

The memory 130 may include a storage area 320 that stores data and a device interface 310 that controls input and output of data with respect to the storage area 320. For example, the storage area 320 may include memory arrays defined by a plurality of storage areas or may include a single storage area (not illustrated).

The processor 120 may perform control such that firmware for the device interface 310 of the memory 130 is updated by using the control command for firmware update and the firmware data, which are stored in the storage area 320 of the memory 130. For example, when the electronic device 100 in booted, the processor 120 may identify (read) a kernel image and RAMdisk information stored in the storage area 320 of the memory 130 and initialize a kernel by using the identified kernel image. For example, the processor 120 may load the kernel image and the RAMdisk information stored in the storage area 320 of the memory 130 into the volatile memory (main memory area), such as a RAM, and initialize the kernel by the kernel image. When the kernel is initialized, the processor 120 may execute the control command for firmware update, which is included in the RAMdisk information to load firmware data for the memory 130. The processor 120 may perform control such that firmware for the device interface 310 of the memory 130 is updated by using the firmware data of the memory 130. When the firmware of the memory 130 is updated, the processor 120 may load system information stored in the storage area 320 of the memory 130 and drive a system.

As another example, when an event for firmware update occurs during running of the electronic device 100, the processor 120 may identify (read) a control command for update of firmware of the memory 130, which is stored in the storage area 320 of the memory 130. For example, the processor 120 may load firmware update information for the memory 130, which is stored in the storage area 320 of the memory 130, into a volatile memory (a main memory area), such as a RAM, a flash memory, or an auxiliary flash memory The processor 120 may un-mount system information and execute the control command for firmware update loaded from the memory 130 to load the firmware data for the memory 130. The processor 120 may perform control such that firmware for the device interface 310 of the memory 130 is updated by using the firmware data of the memory 130.

The processor 120 may manage firmware data of an internal device (e.g., the memory 130). In this case, the processor 120 may execute an application program for management of firmware data or a control command for firmware update to manage firmware data of an internal device (e.g., the memory 130). For example, the processor 120 may perform control such that firmware data provided from an external electronic device (e.g., the other electronic device 104 or the server 106) through the communication module 160 is stored in the storage area 320 of the memory 130. In this case, the processor 120 may perform control such that a version of the firmware data provided from the external electronic device is compared with a firmware version (or a firmware version of the internal device) of firmware data stored in the memory 130, and the firmware data provided from the external electronic device is selectively stored in the storage area 320 of the memory 130. The processor 120 may identify a firmware version of an internal device by using a preset register of the internal device.

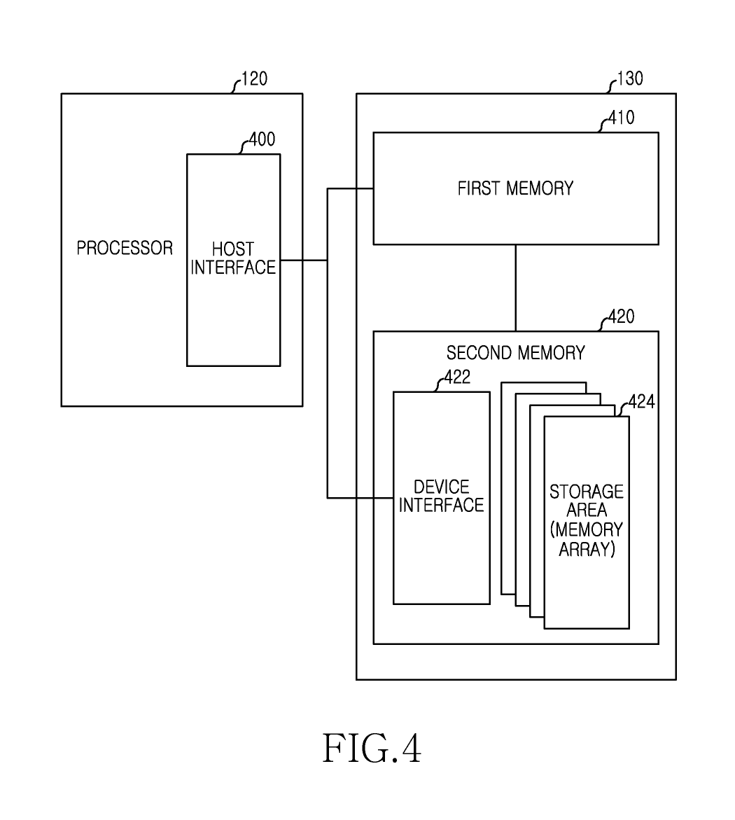

In the above-described embodiment of the present disclosure, the processor 120 may execute a control command for firmware update and load the firmware data stored in the memory 130 into a volatile memory (main memory area), such as a RAM, a flash memory, or an auxiliary flash memory to update the firmware for the device interface 310 of the memory 130. The processor 120 may load firmware data into an internal memory (e.g., an internal RAM) of the processor 120 or a separate memory as illustrated in FIG. 4 to update the firmware for the device interface 310 of the memory 130.

FIG. 4 illustrates a block diagram of an electronic device according to an embodiment of the present disclosure.

Referring to FIG. 4, the processor 120 may include a host interface 400 that controls transmission and reception of data with the memory 130.

The memory 130 may include a first memory 410 into which data to be used by the processor 120 is loaded and a second memory 420 that stores data. The first memory 410 may include at least one of a volatile memory, such as a RAM, and a non-volatile memory, such as a flash memory or an auxiliary flash memory. The second memory 420 may include from a storage area 424 that stores data and a device interface 422 that controls input and output of data to and from the storage area 424. For example, the storage area 424 may include memory arrays defined by a plurality of storage areas or may include a single storage area (not illustrated).

The processor 120 may perform control such that a control command (e.g., an update code) for firmware update, which is stored in the storage area 424 of the second memory 420, is executed, firmware data is loaded into the first memory 410, and the firmware for the device interface 422 of the second memory 420 is updated. For example, when the first memory 410 includes a volatile memory, such as a RAM, the processor 120 may load a kernel image and RAMdisk information stored in the storage area 424 of the second memory 420 into the first memory 410 and initialize a kernel by using the kernel image loaded into the first memory 410 upon booting of the electronic device 100. When the kernel is initialized, the processor 120 may perform control such that a control command for firmware update, which is included in the RAMdisk information, is executed and firmware data stored in the storage area 424 of the second memory 420 into the first memory 410 is loaded to update firmware for the device interface 422 of the second memory 420. When firmware of the second memory 420 is updated, the processor 120 may load system information stored in the storage area 424 of the second memory 420 into the first memory 410 (e.g., a system mount), and drive a system.

As another example, when an event for firmware update occurs during running of the electronic device 100, the processor 120 may identify (read) a control command for firmware update, which is stored in the storage area 424 of the second memory 420 into the first memory 410 (e.g., a RAM, a flash memory, or a secondary flash memory). The processor 120 may unmount system information and perform control such that the control command for firmware update loaded into the first memory 410 is executed and the firmware for the device interface 422 of the second memory 420 is updated.

The processor 120 may manage firmware data of an internal device (e.g., the memory 130). In this case, the processor 120 may execute an application program for management of firmware data or a control command for firmware update to manage firmware data of an internal device (e.g., the memory 130). For example, the processor 120 may perform control such that firmware data provided from an external electronic device (e.g., the other electronic device 104 or the server 106) through the communication module 160 is stored in the storage area 424 of the second memory 420. In this case, the processor 120 may perform control such that a version of the firmware data provided from the external electronic device is compared with a firmware version of firmware data (or a firmware version of the internal device) stored in the second memory 420, and the firmware data provided from the external electronic device is selectively stored in the storage area 424 of the second memory 420. The processor 120 may identify a firmware version of an internal device by using a preset register of the internal device.

In the above-described embodiment of the present disclosure, the memory 130 may include the first memory 410 and the second memory 420. The first memory 410 and the second memory 420 may be configured to be logically or physically separate from each other.

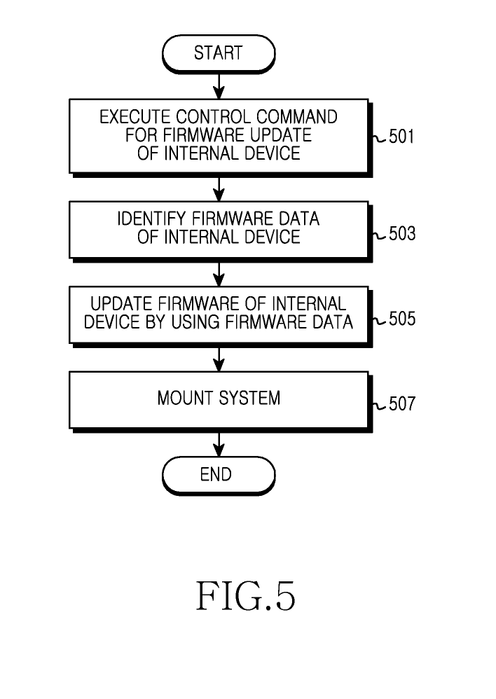

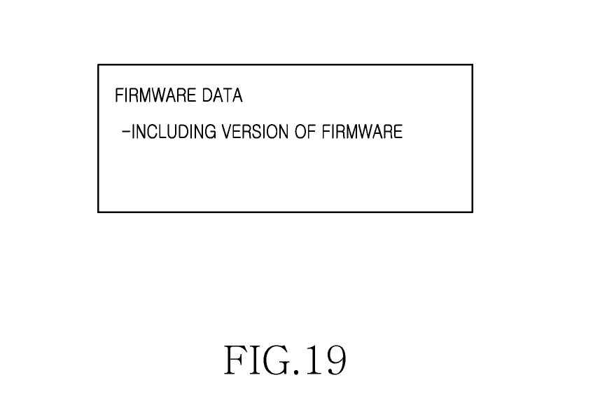

FIG. 5 illustrates a process for updating firmware of an internal device in an electronic device according to an embodiment of the present disclosure. FIG. 19 illustrates a configuration of firmware data according to an embodiment of the present disclosure.

Referring to FIGS. 5 and 19, in operation 501, the electronic device 100 may execute a control command (e.g., an update code) for firmware update of an internal device. For example, in the case of booting, the electronic device 100 may load a kernel image and RAMdisk information stored in the memory 130 into a RAM by using a boot loader. The electronic device 100 may initialize a kernel by using the kernel image loaded into the RAM and then execute the control command for firmware update which is loaded into a RAMdisk area.

In operation 503, the electronic device 100 may identify (read) firmware data for firmware update of an internal device (e.g., the memory 130) from the memory 130. For example, the firmware data stored in the memory 130 includes information on a firmware version of the internal device as illustrated in FIG. 19 and may be configured in the form of at least one file.

In operation 505, the electronic device 100 may update the firmware of the internal device (e.g., the memory 130) by using the firmware data. For example, the electronic device 100 may load the firmware data stored in the memory 130 into a RAM, a flash memory, or an auxiliary flash memory based on the control command for firmware update and update the firmware of the internal device (e.g., the memory 130).

In operation 507, the electronic device 100 may mount a system. For example, the electronic device 100 may load system information stored in the memory 130 into the RAM.

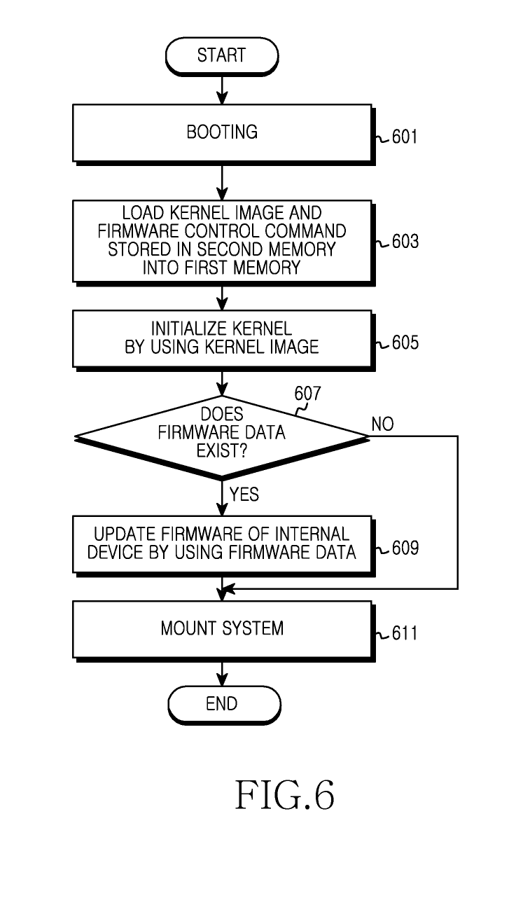

FIG. 6 illustrates a process for updating firmware of an internal device at the time of booting in an electronic device according to an embodiment of the present disclosure.

Referring to FIG. 6, in operation 601, the electronic device 100 may start booting the electronic device 100. For example, when power is applied to the electronic device 100, the electronic device 100 may start booting the electronic device 100 by using a boot loader.

In operation 603, the electronic device 100 may load a kernel image and RAMdisk information stored in the second memory 420 into the first memory 410 (e.g., a RAM).

In operation 605, the electronic device 100 may initialize the kernel by using the kernel image loaded into the first memory 410.

In operation 607, the electronic device 100 may execute a control command for firmware update which is loaded into a RAMdisk area and determine whether firmware data for an internal device of which firmware is to be updated is present in the electronic device 100. For example, the electronic device 100 may determine whether the firmware data for the internal device of which firmware is to be updated is stored in the storage area 424 of the second memory 420.

When the firmware data for the internal device of which firmware is to be updated is not present in operation 607, the electronic device 100 may recognize that it is hard to update the firmware of the internal device. Therefore, in operation 611, the electronic device 100 may mount a system. For example, the electronic device may load system information stored in the storage area 424 of the second memory 420 into the first memory 410 (e.g., a RAM).

When the firmware data for the internal device of which firmware is to be updated is present in operation 607, the electronic device 100 may update the firmware of the internal device (e.g., the second memory 420) by using the firmware data for the internal device in operation 609. For example, when the firmware data is stored in the second memory 420, the electronic device 100 may load the firmware data stored in the second memory 420 into the first memory 410 (e.g., a RAM) and update firmware for the device interface 422 of the second memory 420.

In operation 611, the electronic device may mount a system.

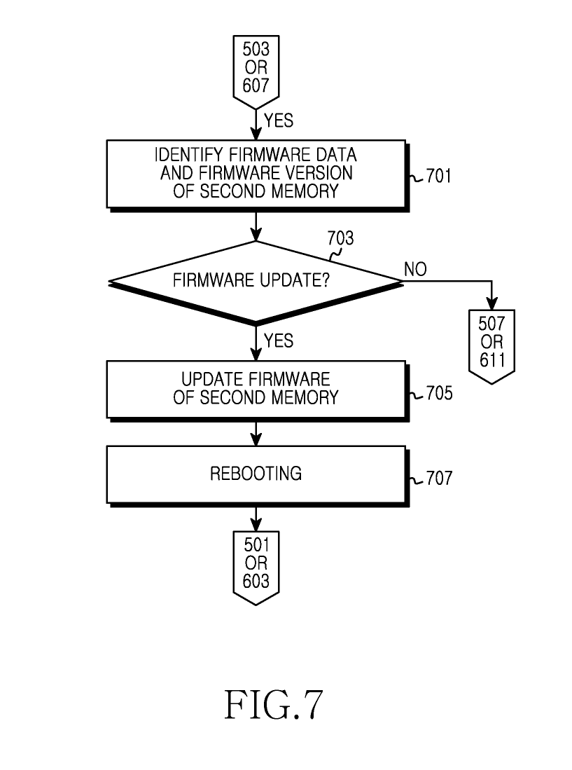

FIG. 7 illustrates a process for updating firmware of an internal device based on a firmware version in an electronic device according to an embodiment of the present disclosure.

Referring to FIG. 7, when identifying the firmware data in operation 503 of FIG. 5, or when determining that the firmware data for an internal device of which firmware is to be updated is present in operation 607 of FIG. 6, the electronic device 100 may identify a version of the firmware data and a firmware version of the internal device (e.g., a memory) of which the firmware is to be updated in operation 701. For example, the electronic device 100 may identify a firmware version of an internal device by using a preset register of the internal device.

In operation 703, the electronic device 100 may compare a version of the firmware data with a firmware version of the internal device (e.g., the memory) of which firmware is to be updated and determine whether to update the firmware of the internal device (e.g., the memory). For example, when the version of the firmware data is identical to or older than the firmware version of the internal device (e.g., the memory), the electronic device 100 may determine that it is not required to update the firmware of the memory. When the version of the firmware data is newer than the firmware version of the internal device (e.g., the memory), the electronic device 100 may determine that it is required to update the firmware of the internal device (e.g., the memory).

When it is determined that it is not required to update the firmware of the internal device (e.g., the memory) in operation 703, the electronic device 100 may mount a system in operation 507 of FIG. 5 or operation 611 of FIG. 6.

When it is determined that it is required to update the firmware of the internal device (e.g., memory) in operation 703, the electronic device 100 may update the firmware of the internal device (e.g., a device interface for the memory) in operation 705.

In operation 707, the electronic device may reboot and initialize a system.

When the system is rebooted in operation 707, the electronic device may execute the control command for firmware update in operation 501 of FIG. 5, or may load the kernel image and the RAMdisk information stored in the second memory 420 into the first memory 410 (e.g., RAM) in operation 603 of FIG. 6.

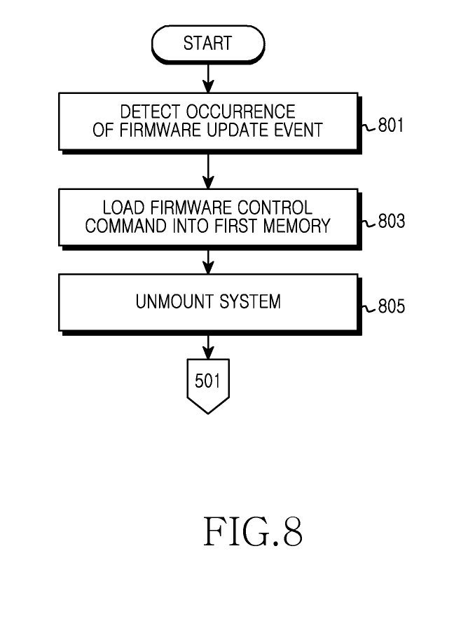

FIG. 8 illustrates a process for updating firmware of an internal device during running in an electronic device according to an embodiment of the present disclosure.

Referring to FIG. 8, in operation 801, the electronic device 100 may detect occurrence of an event for firmware update during running of a system. For example, the electronic device may determine whether an event for firmware update occurs based on input information provided through the input module 140. The event for firmware update may include an event for a system recovery mode.

In operation 803, the electronic device 100 may load a control command (e.g., an update code) for firmware update stored in the second memory 420 into the first memory 410 (e.g., a RAM, a flash memory, or an auxiliary flash memory).

In operation 805, the electronic device may unmount system information. For example, the electronic device 100 may remove system information which is loaded into the first memory 410.

At the time of unmounting the system, the electronic device may execute the control command for firmware update of an internal device (e.g., the second memory 420) in operation 501 of FIG. 5.

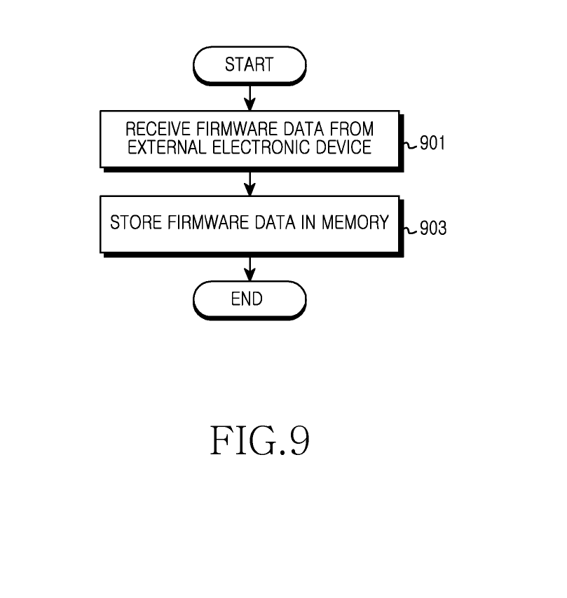

FIG. 9 illustrates a process for storing firmware data in an electronic device according to an embodiment of the present disclosure.

Referring to FIG. 9, in operation 901, the electronic device 100 may receive firmware data from an external electronic device. For example, the electronic device 100 may receive the firmware data for firmware update of an internal device from the other electronic device 104 or the server 106 which manages firmware data, through the communication module 160.

In operation 903, the electronic device 100 may store the firmware data provided from the external electronic device in the memory 130. For example, the electronic device 100 may store the firmware data in a memory area logically or physically separate from the control command for firmware update of the internal device. As another example, the electronic device 100 may update firmware data stored in the memory 130 by using the firmware data provided from the external electronic device.

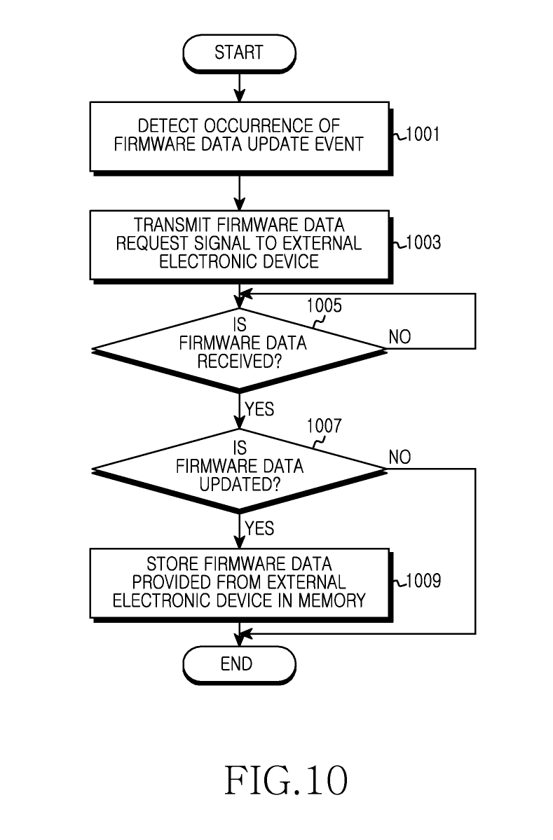

FIG. 10 illustrates a process for selectively storing firmware data provided from an external electronic device in an electronic device according to an embodiment of the present disclosure.

Referring to FIG. 10, in operation 1001, the electronic device may detect occurrence of an event for firmware data update. For example, the electronic device 100 may determine whether an application program for management of firmware data is driven based on input information detected through the input module 140. As another example, the electronic device 100 may determine whether a control menu for updating of firmware data is selected based on input information detected through the input module 140.

In operation 1003, the electronic device 100 may transmit a firmware data request signal to an external device in response to the event for updating of firmware data. For example, when occurrence of the event for updating of firmware data is detected, the electronic device 100 may execute an application program for management of firmware data and a control command for firmware update and transmit the firmware data request signal to an external device in response to the event for updating of firmware data. In this case, the firmware data request signal may include at least one of identification information of the electronic device and identification information of the internal device corresponding to firmware data.

In operation 1005, the electronic device 100 may determine whether firmware data is received from an external electronic device.

When firmware data is not received from the external electronic device in operation 1005, the electronic device 100 may determine whether firmware data is received from the external electronic device in operation 1005. As another example, when firmware data is not received until a reference time has elapsed, the electronic device 100 may transmit the firmware data request signal to the external device in operation 1003.

When firmware data is received from the external electronic device in operation 1005, the electronic device 100 may compare a version of firmware data received from the external electronic device with a firmware version of firmware data (or a firmware version of the internal device) stored in the memory 130 and determine whether to update the firmware data stored in the memory 130. For example, when a version of firmware data provided from the external electronic device is newer than a version of firmware data (or a firmware version of the internal device) stored in the memory 130 (e.g., the latest version), the electronic device 100 may determine to update the firmware data stored in the memory 130. The electronic device 100 may identify a firmware version of an internal device by using a preset register of the internal device.

When it is determined to update the firmware data stored in the memory 130 in operation 1007, the electronic device 100 may update the firmware data stored in the memory 130 by using the firmware data received from the external electronic device in operation 1009.

When it is determined not to update the firmware data stored in the memory 130 in operation 1007, the electronic device 100 may end the present algorithm.

When the firmware data stored in the memory 130 is updated by using the firmware data received from the external electronic device in operation 1009 of FIG. 10, the electronic device 100 may recognize updating of firmware data as occurrence of an event for firmware update (operation 801 of FIG. 8). Therefore, when the electronic device 100 updates the firmware data stored in the memory 130, the electronic device 100 may update firmware of an internal device by using the updated firmware data as illustrated in FIG. 8.

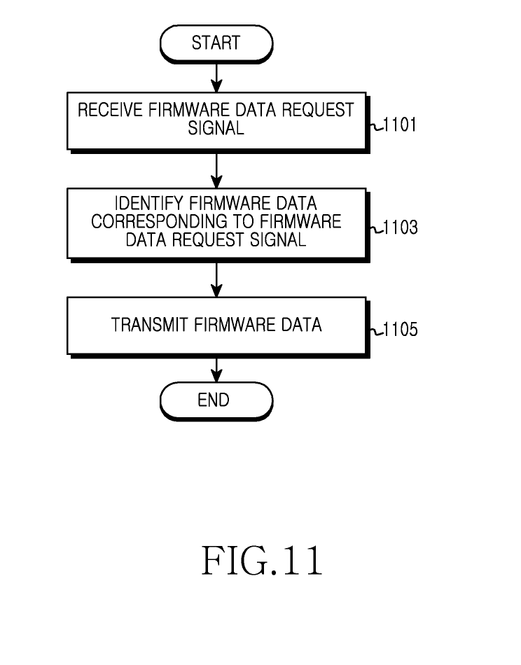

FIG. 11 illustrates a process for transmitting firmware data in an external electronic device according to an embodiment of the present disclosure. There will be described a feature of the present disclosure to transmit firmware data corresponding to the electronic device storing firmware data as described with reference to FIG. 10 in an external electronic device.

Referring to FIG. 11, in operation 1101, the external electronic device may receive a firmware data request signal from an electronic device 100.

In operation 1103, the external electronic device may identify firmware data corresponding to the firmware data request signal. For example, the external electronic device may identify firmware data corresponding to at least one of identification information of the electronic device and identification information of an internal device corresponding to the firmware data which are included in the firmware data request signal.

In operation 1105, the external electronic device may transmit firmware data corresponding to the firmware data request signal to the electronic device 100.

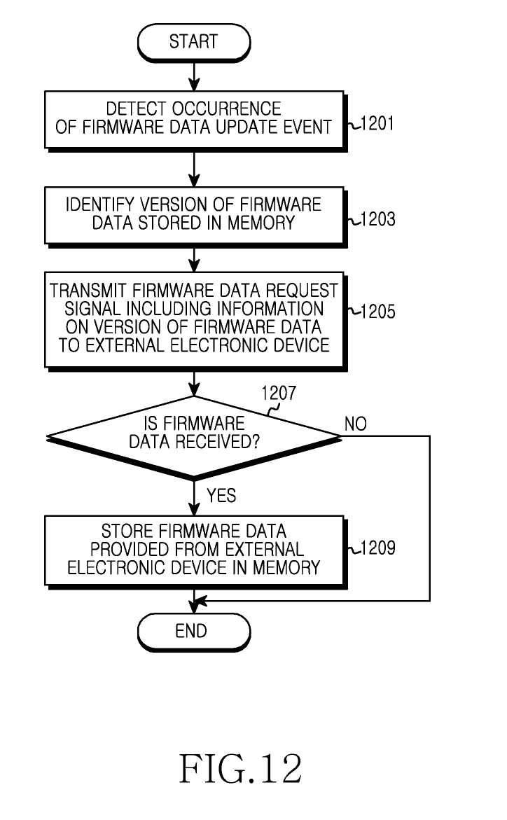

FIG. 12 illustrates a process for storing firmware data provided from an external electronic device in an electronic device according to an embodiment of the present disclosure.

Referring to FIG. 12, in operation 1201, the electronic device 100 may detect occurrence of an event for updating of firmware data.

In operation 1203, the electronic device 100 may identify a version of firmware data (or a firmware version of an internal device) stored in the memory 130. For example, when identifying the firmware version of the internal device, the electronic device 100 may execute an application program for management of firmware data or a control command for firmware update and identify (read) a firmware version of an internal device from a preset register of the internal device.

In operation 1205, the electronic device 100 may transmit a firmware data request signal, which includes a version of firmware data (or a firmware version of an internal device), to an external electronic device. In this case, the firmware data request signal may additionally include at least one of identification information of the electronic device and identification information of an internal device corresponding to firmware data.

In operation 1207, the electronic device 100 may determine whether firmware data is received from the external electronic device.

When firmware data is not received from the external electronic device until a reference time has elapsed after transmission of the firmware data request signal in operation 1207, the electronic device 100 may recognize that firmware data is not to be updated and end the present algorithm.

When the firmware data is received from the external electronic device in operation 1207, the electronic device 100 may update the firmware data stored in the memory 130 by using the firmware data received from the external electronic device in operation 1209.

When the firmware data stored in the memory 130 is updated by using the firmware data received from the external electronic device in operation 1209 of FIG. 12, the electronic device 100 may recognize updating of firmware data as occurrence of an event for firmware update (operation 801 of FIG. 8). Therefore, when the electronic device 100 updates the firmware data stored in the memory 130, the electronic device 100 may update firmware of an internal device by using the updated firmware data as illustrated in FIG. 8.

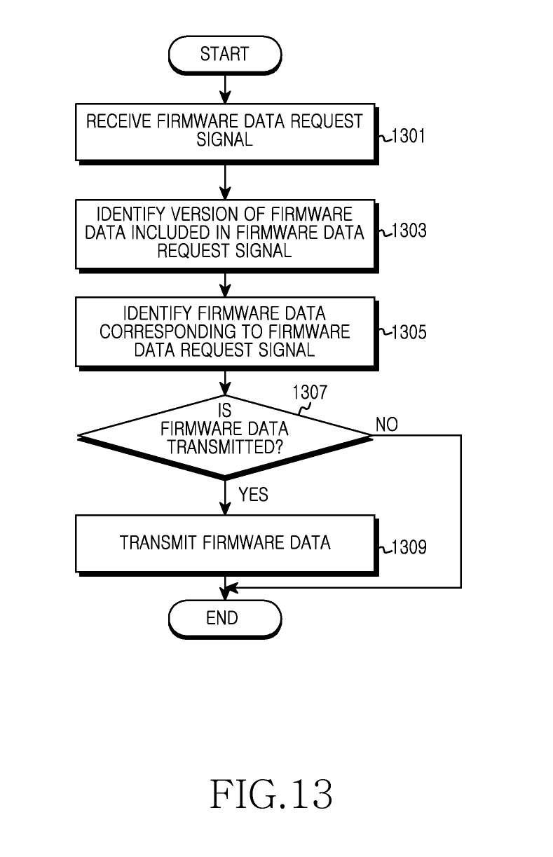

FIG. 13 illustrates a process for selectively transmitting firmware data in an external electronic device according to an embodiment of the present disclosure. There will be described a feature of the present disclosure to transmit firmware data corresponding to the electronic device storing firmware data as described with reference to FIG. 12 in an external electronic device.

Referring to FIG. 13, in operation 1301, the external electronic device may receive a firmware data request signal from an electronic device 100.

In operation 1303, the external electronic device may identify version information of firmware data included in the firmware data request signal.

In operation 1305, the external electronic device may identify firmware data corresponding to the firmware data request signal. For example, the external electronic device may identify firmware data corresponding to at least one of identification information of the electronic device and identification information of an internal device corresponding to the firmware data which are included in the firmware data request signal.

In operation 1307, the external electronic device may determine whether to transmit firmware data to the electronic device based on a version of firmware data (or a firmware version of the internal device). For example, when a version of firmware data identified in operation 1305 is newer than a version of firmware data (or a firmware version of the internal device) stored in the electronic device 100 which is identified in operation 1303 (e.g., the latest version), the external electronic device may determine to transmit the firmware data to the electronic device.

When it is determined to transmit the firmware data to the electronic device in operation 1307, the external electronic device may transmit the firmware data corresponding to the firmware data request signal to the electronic device in operation 1309.

When it is determined not to transmit the firmware data to the electronic device in operation 1307, the external electronic device may end the present algorithm.

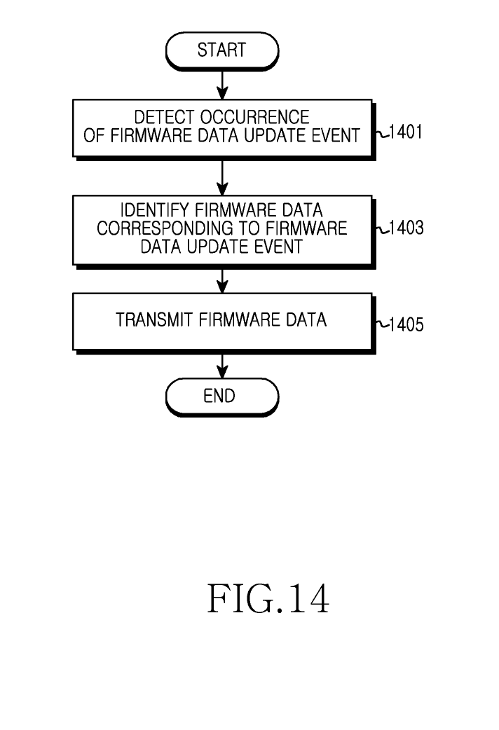

FIG. 14 illustrates a process for transmitting firmware data in an external electronic device according to an embodiment of the present disclosure.

Referring to FIG. 14, in operation 1401, the external electronic device may detect occurrence of an event for updating of firmware data. For example, the external electronic device may determine whether a firmware data update period for the electronic device 100 is reached. As another example, the external electronic device may determine whether a user input corresponding to updating of firmware data for the electronic device 100 is detected.

In operation 1403, the external electronic device may identify firmware data corresponding to an event for updating of firmware data. For example, the external electronic device may identify firmware data of an electronic device corresponding to an event for updating of firmware data and firmware data of an internal device of the electronic device.

In operation 1405, the external electronic device may transmit firmware data to an electronic device corresponding to the event for updating of firmware data.

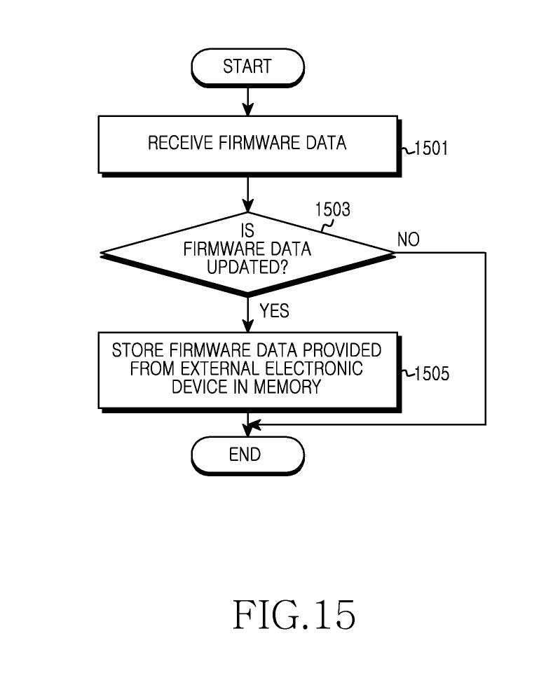

FIG. 15 illustrates a process for selectively storing firmware data provided from an external electronic device in an electronic device according to another embodiment of the present disclosure. There will be described a feature of the present disclosure to update firmware data corresponding to an external electronic device transmitting firmware data as described with reference to FIG. 14 in an electronic device.

Referring to FIG. 15, in operation 1501, the electronic device 100 may receive firmware data from an external electronic device.

In operation 1503, the electronic device 100 may determine whether to update firmware data stored in the memory 130 based on a version of firmware data received from the external electronic device. For example, the electronic device 100 may execute an application program for management of firmware data or a control command for firmware update and identify (read) a firmware version of an internal device from a preset register of the internal device. The electronic device 100 may compare a version of firmware data received from the external electronic device with a firmware version of firmware data (or a firmware version of the internal device) stored in the memory 130 and determine whether to update the firmware data stored in the memory 130.

When it is determined to update the firmware data stored in the memory 130 in operation 1503, the electronic device 100 may update the firmware data stored in the memory 130 by using the firmware data received from the external electronic device in operation 1505.

When it is determined not to update the firmware data stored in the memory 130 in operation 1503, the electronic device 100 may end the present algorithm.

When the firmware data stored in the memory 130 is updated by using the firmware data received from the external electronic device in operation 1505 of FIG. 15, the electronic device 100 may recognize updating of firmware data as detection of occurrence of an event for firmware update (operation 801 of FIG. 8). Therefore, when the electronic device 100 updates the firmware data stored in the memory 130, the electronic device 100 may update firmware of an internal device by using the updated firmware data as illustrated in FIG. 8.

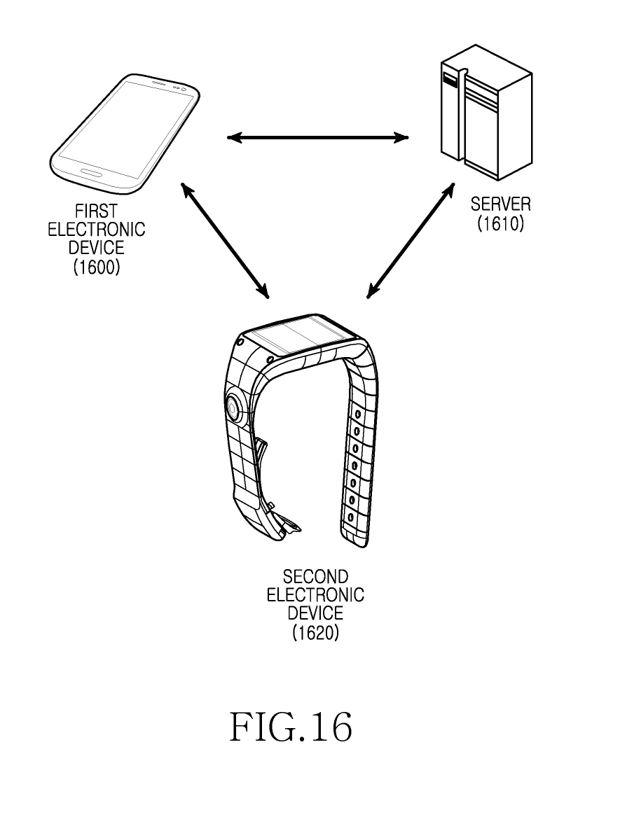

FIG. 16 illustrates a configuration for transmitting firmware data according to an embodiment of the present disclosure.

Referring to FIG. 16, the electronic device 100 may store (or update) firmware data provided from an external electronic device (e.g., the other electronic device 104 or the server 106) in the memory 130.

When the electronic device 100 is a first electronic device 1600, such as a smart phone, a tablet PC, a mobile phone, and the like, the first electronic device 1600 may receive firmware data from a server 1610 and store the firmware data in a memory of the first electronic device 1600. For example, the first electronic device 1600 may update firmware data stored in the memory by using the firmware data provided from the server 1610.

When the electronic device 100 is a second electronic device 1620, such as a wearable device, the second electronic device 1620 may receive firmware data from the first electronic device 1600 or the server 1610 and store the firmware data in a memory of the second electronic device 1620. For example, the second electronic device 1620 may update firmware data stored in the memory by using the firmware data provided from the first electronic device 1600 or the server 1610.

In the above-described embodiment of the present disclosure, when an application program for managing firmware data is executed, the electronic device 100 may recognize that an event for updating of firmware data occurs and update firmware data as illustrated in FIG. 10 or FIG. 12.

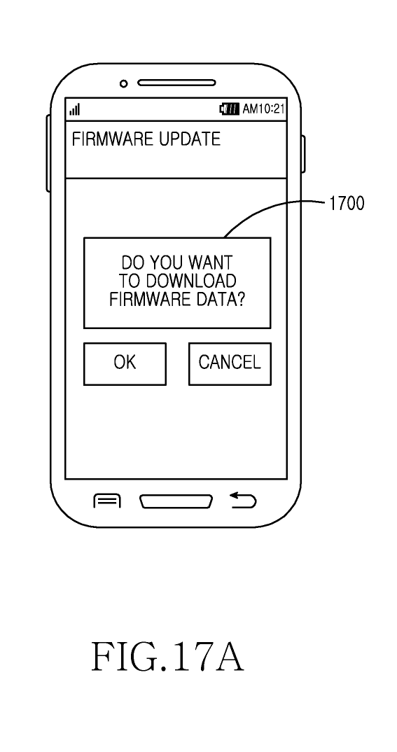

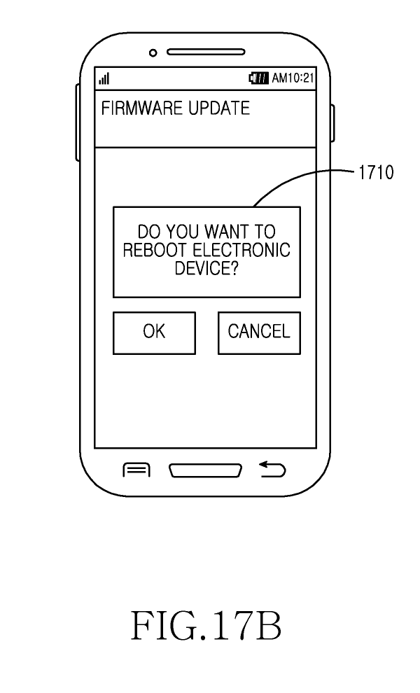

FIGS. 17A and 17B illustrate screen configurations for management of firmware data according to various embodiments of the present disclosure.

Referring to FIGS. 17A and 17B, when the application program for managing firmware data is executed, the electronic device 100 may selectively update firmware data based in input information detected through the input module 140. For example, when the application program for managing firmware data is executed, the electronic device 100 may display control information (e.g., a control menu) 1700 for determining whether to download firmware data on the display module 150 as illustrated in FIG. 17A. When it is determined to perform download based on input information for the control information detected through the input module 140, the electronic device 100 may recognize that an event for updating of firmware data occurs in FIG. 10 or 12, and update firmware data.

In the above-described embodiment of the present disclosure, when the electronic device 100 updates firmware data stored in the memory 130 by using firmware data received from an external electronic device, the electronic device 100 may recognize that the event for firmware update and perform firmware update of an internal device as illustrated in FIG. 8.

In another embodiment of the present disclosure, when the electronic device 100 updates firmware data stored in the memory 130, the electronic device 100 may selectively update firmware for the internal device based on the input information detected through the input module 140. For example, when updating firmware data, the electronic device 100 may display control information (e.g., a control menu) 1710 for determining whether to update firmware on the display module 150 by using the application program for managing firmware data as illustrated in FIG. 17B. When it is determined to perform firmware update based on input information for control information detected through the input module 140, the electronic device 100 may recognize that an event for firmware update occurs in operation 801 of FIG. 8, and perform updating of firmware of the internal device.

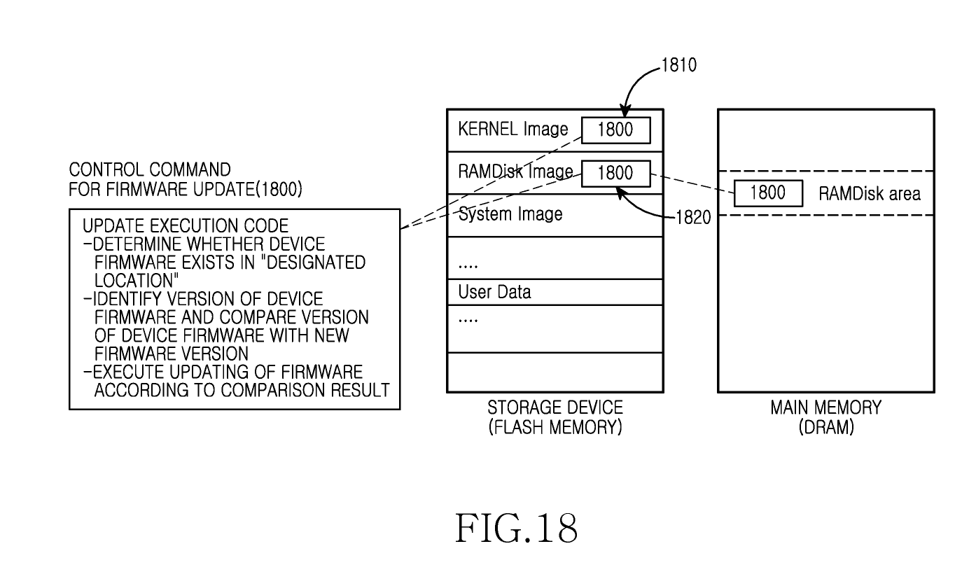

FIG. 18 illustrates a configuration of a memory in which a control command for a firmware update is executed according to an embodiment of the present disclosure.

Referring to FIG. 18, a control command 1800 for firmware update of an internal device may be stored as a part of a kernel image in a storage device (e.g., a flash memory) (auxiliary memory device) (1810) or may be stored as a part of a RAMdisk image which is logically or physically separate from a kernel image, in a storage device (e.g., a flash memory) (auxiliary memory device) (1820). For example, when the electronic device 100 is booted, the control command 1800 for firmware update may be loaded into a partial area (e.g., a RAMdisk area) of a main memory (e.g., a RAM, a dynamic RAM (DRAM), and the like) by a boot loader of the electronic device 100 and be executed by the processor 120 of the electronic device 100 or the firmware control module 170. For example, the control command 1800 for firmware update may be stored in a storage device through a method, such as firmware over-the-air (FOTA).

When the control command (1800) for firmware update is executed, the control command (execution code) 1800 may determine whether firmware data exists in the memory 130 of the electronic device 100. For example, the control command 1800 may determine whether firmware data exists in a preset area of the memory 130.

When the firmware data exists, the control command 1800 may be provided to compare a firmware version of an internal device with a version of firmware data and perform updating of firmware of the internal device based on a comparison result.

As described above, the electronic device updates firmware of an internal device (e.g., a storage device) in a state in which input and output with respect to the internal device are restricted, thereby stably updating firmware for the internal device.

The electronic device stores and executes a control command (e.g., an update code) for updating firmware of an internal device and firmware data as an independent execution file, thereby updating firmware of the internal device without newly generating host firmware.

The electronic device separates a control command (e.g., an update code) for updating firmware of an internal device and firmware data from each other, thereby easily storing and updating firmware data.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for updating firmware of an internal device in an electronic device, the method comprising:
executing a control command for a firmware update of the internal device;
detecting data for the firmware update of the internal device; and
updating the firmware of the internal device based on the detected data.

2. The method of claim 1, wherein the executing of the control command comprises executing the control command for the firmware update which is allocated in a random access memory (RAM) disk area.

3. The method of claim 1, wherein the executing of the control command comprises:
loading the control command for the firmware update into a RAMdisk area at a time point at which a kernel image is loaded into a RAM upon booting of the electronic device;
initializing a kernel based on the kernel image; and
executing the control command for the firmware update which is loaded into the RAMdisk area.

4. The method of claim 1, wherein the detecting of the data for the firmware update comprises loading the data for the firmware update stored in a memory area which is logically or physically separate from the control command for the firmware update into a RAM, a flash memory, or an auxiliary flash memory.

5. The method of claim 1, wherein the updating of the firmware of the internal device comprises updating firmware of a storage device included in the electronic device based on information on the firmware update.

6. The method of claim 5, wherein the updating of the firmware of the storage device comprises updating firmware for a device interface by the storage device included in the electronic device, the storage device including a storage area storing the data and the device interface for controlling input and output of the data with respect to the storage area.

7. The method of claim 1, further comprising:
loading the control command for the firmware update of the internal device into a RAM, a flash memory, or an auxiliary flash memory during running of the electronic device before executing the control command; and
unmounting system information of the electronic device.

8. The method of claim 1, further comprising:
receiving the data for the firmware update from an external electronic device; and
updating the data for the firmware update stored in a memory area logically or physically separate from the control command for the firmware update based on the received data for the firmware update.

9. The method of claim 8, further comprising:
identifying a firmware version of the internal device or a version of the data for the firmware update stored in the memory area before receiving the data; and
transmitting a data request signal including information on the firmware version of the internal device or the version of the data for the firmware update stored in the memory area to the external electronic device.

10. The method of claim 8, wherein the external electronic device comprises another electronic device or a server.

11. An electronic device comprising:
at least one internal device; and
at least one processor configured:
to execute a control command for a firmware update of the at least one internal device for updating of firmware of the at least one internal device,
to detect data for the firmware update of the at least one internal device, and
to update the firmware of the at least one internal device based on the detected data.

12. The electronic device of claim 11, further comprising a random access memory (RAM),
wherein the processor is further configured to execute the control command for the firmware update allocated to a RAMdisk area of the RAM.

13. The electronic device of claim 11, further comprising a RAM,
wherein the processor is further configured:
to load the control command for the firmware update into a RAMdisk area of the RAM at a time point at which a kernel image is loaded into the RAM upon booting of the electronic device,
to initialize a kernel based on the kernel image, and
to execute the control command for the firmware update loaded into the RAMdisk area.

14. The electronic device of claim 11, further comprising at least one of a RAM, a flash memory, or an auxiliary flash memory,
wherein the processor is further configured:
to load the data for the firmware update stored in a memory area logically or physically separate from the control command for the firmware update into the RAM, the flash memory, or the auxiliary flash memory, and
to update the firmware of the at least one internal device.

15. The electronic device of claim 11, further comprising a storage device including a storage area configured to store the data and a device interface configured to control input and output of the data with respect to the storage area,
wherein the processor is further configured to update firmware for the device interface of the storage device.

16. The electronic device of claim 11, further comprising at least one of a RAM, a flash memory, or an auxiliary flash memory,
wherein the processor is further configured:
to load the control command for the firmware update of the at least one internal device for updating of firmware of the at least one internal device into the RAM, the flash memory, or the auxiliary flash memory,
to unmount system information of the electronic device, and
to execute the control command for the firmware update during running of the electronic device.

17. The electronic device of claim 11, further comprising a communication module configured to transmit and receive a signal with an external electronic device,
wherein the processor is further configured to update the data for the firmware update stored in the memory area logically or physically separate from the control command for the firmware update based on the data for the firmware update received from the external electronic device through the communication module.

18. The electronic device of claim 17, wherein the processor is further configured to transmit a data request signal including information on a firmware version of the at least one internal device or a version of the data for the firmware update stored in the memory to the external electronic device through the communication module in order to receive the data for the firmware update from the external electronic device.

19. The electronic device of claim 17, wherein the external electronic device comprises another electronic device or a server.

20. A non-transitory computer-readable storage medium for storing a computer program of instructions configured to be readable by at least one processor for instructing the at least one processor to execute a computer process for performing the method of claim 1.
